(19) United States
(12) Patent Application Publication
(10) Pub. No.: US 2026/0042266 A1
(43) Pub. Date: Feb. 12, 2026

(54) A METHOD FOR MANUFACTURING A COMPOSITE STRUCTURE USING RECYCLED FIBRE MATS

(71) Applicant: VESTAS WIND SYSTEMS A/S, Aarhus N (DK)

(72) Inventors: Troels Bach NIELSEN, Risskov (DK); Aksel PETERSEN, Ringkøbing (DK); Adrian GILL, East Cowes (GB)

(21) Appl. No.: 19/150,066

(22) PCT Filed: Jan. 31, 2024
(86) PCT No.: PCT/DK2024/050018

§ 371 Date: Jul. 22, 2025

(30) Foreign Application Priority Data
Jan. 31, 2023 (DK) PA202370054

(51) Int. Cl. B29C 70/44; B29B 17/02; B29C 70/00; B29C 70/22; B29K 105/08; B29K 105/26; B29L 31/08

(52) U.S. Cl. CPC B29C 70/443; B29B 17/02; B29C 70/003; B29C 70/22; B29K 2105/08; B29K 2105/26; B29L 2031/085

(57) ABSTRACT

A method for manufacturing a composite structure (24), such as an epoxy composite structure, is disclosed Layers of fibre mats (13) are arranged in a mould (18), the fibre mats (13) comprising oriented fibres. A resin is infused in the layers of fibre mats (13), and the resin is cured to form the composite structure (24). The fibre mats (13) are recycled fibre mats (13), e.g. retrieved from an original composite structure, such as a wind turbine blade (6).

### FIELD OF THE INVENTION

The present invention relates to a method for manufacturing a composite structure using recycled fibre mats which have been retrieved from previous composite structures, such as wind turbine blades or parts of wind turbine blades.

### BACKGROUND OF THE INVENTION

At the end of their lifetime, composite structures, such as wind turbine blades, need to be disposed of. This could, e.g., involve depositing the composite structure in a landfill, possibly after cutting the composite structure into smaller parts. In order to reduce the environmental footprint, there is a desire to at least partly recycle composite structures. However, due to the composite nature of these structures, it is difficult to separate the structures into their original constituent parts, and this renders appropriate recycling of material difficult, or even impossible. For instance, the composite structures may comprise fibres arranged in a matrix of a cured resin, e.g. an epoxy based resin. Once cured, it is not possible to mechanically separate the fibres from the resin.

One previous approach for recycling composite structures, such as epoxy composite structures, is to subject the composite structure to shredding or grinding, and subsequently performing a separation process on the shredded or grinded material, in order to mechanically separate the fibres from the resin material. However, the fibres as well as the resin material retrieved in this manner are often contaminated, i.e. the fibres are contaminated by resin material and the resin material is contaminated by fibres. Accordingly, the retrieved fibres as well as the retrieved resin material is unsuitable for recycling for high quality products, or significant processing of the composite material may be required in order to allow recycling of the material.

### DESCRIPTION OF THE INVENTION

It is an object of embodiments of the invention to provide a method for manufacturing a composite structure with a low environmental impact.

The invention provides a method for manufacturing a composite structure, the method comprising the steps of:
arranging layers of fibre mats in a mould, the fibre mats comprising oriented fibres,
infusing a resin in the layers of fibre mats, and
curing the resin to form the composite structure,
wherein the fibre mats are recycled fibre mats.

Thus, the invention provides a method for manufacturing a composite structure. In the present context the term ‘composite structure’ should be interpreted to mean a structure which is made from a composite material, i.e. a material which comprises suitable fibres embedded in a matrix of cured resin.

In the method according to the invention, layers of fibre mats are initially arranged in a mould. In the present context the term ‘fibre mat’ should be interpreted to mean a substantially two-dimensional or sheet-like item made exclusively or primarily from fibres. The layers of fibre mats form the fibres of the composite material of the resulting composite structure. The mould defines a size and shape which the resulting composite structure is intended to have.

The fibre mats comprise oriented fibres, e.g. in the form of unidirectional fibres, bidirectional fibres, woven fibres, or otherwise oriented fibres. Thus, the fibres of the respective fibre mats follow a well defined orientation or pattern, which can be relied upon when the fibre mats are arranged in the mould. The orientation of the fibres of the individual fibre mats may differ from each other.

In addition to arranging fibre mats in the mould, individual fibres may also be arranged in the mould. Such individual fibres may be recycled fibres or virgin fibres.

When the layers of fibre mats have been arranged in the mould, a resin is infused in the layers of fibre mats. The infusion may, e.g., include subjecting the resin and the fibre mats to a vacuum. The resin may, e.g., be an epoxy based resin, in which case the resulting composite structure is an epoxy composite structure.

Finally, the resin is cured so as to form a matrix of cured resin in which the fibre mats are embedded, and thereby form the composite structure. The curing may be a chemically activated curing where a hardener may be added to the resin prior to infusion. Alternatively or additionally, the curing may be thermal curing in which it is required to apply heat to the resin, or UV curing in which it is required to apply ultraviolet light to the resin. It is preferred that the resin used in the composite structure is an epoxy resin. Particularly, it is preferred that the resin is an amine cured epoxy resin as it was found that such resin systems may be disintegrated by formic acid on an industrial scale and thereby allowing for are readily retrieval of the fibre mats for future further reuse in the method according to the invention.

The fibre mats which are used for forming the composite structure as described above are recycled fibre mats. Accordingly, the fibre mats have been retrieved from a previous structure or product, e.g. from another composite structure, and they are applied in the composite structure being manufactured in accordance with the method according to the present invention in their retrieved form. For instance, the orientation of the fibres defined in a given fibre mat as it was applied in the previous product or structure is maintained.

The recycled fibre mats may comprise smaller amounts of residual resin of the composite structure from which they were retrieved. It is preferred that the recycled fibre mats used in the methods to the invention comprises less than 4 wt-% epoxy resin. Such small amounts of residual resin will typically be acceptable, particularly when the residual resin is bonded to the surface of the fibre mats. Small amounts of residual resin may in some cases act as a sizing in that new resin of similar type may bond easily to the particles and hence may lead to a better overall bonding between the resin infused into the layers of fibre mats in the method of the invention and the fibres of the recycled fibre mats. However, it is preferred that the recycled fibre mats comprise very little residual resin such as less than 1 wt-% epoxy resin and more preferably the recycled fibre mats comprise less than 0.5 wt-% epoxy. Reduction of the residual epoxy resin may require post treatment after the disintegration by the release agent, such as mechanical or chemical post treatment, and it may be preferred that the recycled fibre mats comprise substantially no residual resin when used on the method of the invention. When selecting the reused fibre mats for manufacturing a composite structure according to the invention, it may be advantageous that the resin used for infusion is of the same type as the residual resin is the reused fibre mats, particularly if the amount of residual resin is relatively high, such as 5-2 wt-% residual resin in the fibre mats. More specifically, it was found that the resin used for infusion preferably may be disintegrated by the same process as the residual resin, as this allows for further retrieval of the fibre mats at the end of the lifetime of the composite structure manufacture according to the present invention without leaving excessive waste in the process.

It is preferred that the recycled fibre mats used in the method of the present invention are of a size that facilitate reuse including possible orientation of the fibre mats during arrangement in a mould for resin infusion. In some examples, the recycled fibre mats have an area of at least 100 cm² corresponding to for example at least 10 cm×at least 10 cm. Smaller recycled mats with areas of down to about 100 cm² may typically be used with random layup in larger moulds or for very small new composite structures, such as carrier layer in printed circuit boards, PCB. Preferably, the area of the recycled mats are at least 2500 cm² such as at least 50 cm×at least 50 cm. However, larger pieces such as at least 1 m² are in most applications preferred, as this allows for easily taking into consideration the orientation of the fibres of the mats when arranging the fibre mats during layup of the recycled fibre mats. For practical reasons, it is preferred that the width of the fibre mats are less than 2 meters as larger sizes may be complicated to handle. In one example, the size and/or shape of the recycled fibre mats are standardized, such as squares of 10 cm×10 cm, 25 cm×25 cm, 50 cm×50 cm or rectangular, such as 10 cm×100 cm or 25 cm×100 cm. Using a standardized size and/or shape allows for easier design of layups that may overcome the need for characterising of each recycled fibre mat individually.

Thus, the fibre mats are retrieved, in one piece, from a previous product or structure, where the overall structure of the fibre mat which was originally applied when the previous product or structure was manufactured is maintained, and the retrieved fibre mats are reused directly, in their retrieved form, in the new composite structure. Accordingly, minimal processing of the recycled fibre material is required. For instance, it is neither necessary to remelt the (glass) fibre material, nor to produce new fibres or separate recycled mats into separate individual recycled fibres and rearrange such fibres into fibre mats. Finally, the reused fibre mats reduce the need for virgin material for producing the composite structure. In summary, the composite structure is manufactured with minimal environmental impact.

At least one of the recycled fibre mats may, e.g., be retrieved from a previous composite structure in the following manner. The previous composite structure may be subjected to a release agent, such as a release agent comprising acid, such as formic acid or another suitable kind of acid, e.g. acetic acid. This could, e.g., include partly or completely submerging the previous composite structure in a vessel or container accommodating the release agent. Such recycled fibre mats may comprise particles of the resin of the previous composite structure chemically or physically stuck to the fibres.

The release agent causes disintegration of the previous composite structure. This could, e.g., include swelling of polymers of the resin of the previous composite structure and/or dissolving of the resin of the previous composite structure. In any event, as a result of exposing the previous composite structure to the release agent, the previous composite structure disintegrates to the extent that at least one fibre mat and the resin are separated, i.e. the at least one fibre mat is released from the matrix of resin.

Finally, the at least one fibre mat is retrieved from the disintegrated previous composite structure. This is possible due to the separation of the fibre mat and the resin caused by the release agent, and as described above. Accordingly, the fibres are retrieved from the previous composite structure, in the form of a fibre mat, i.e. a substantially two-dimensional structure, in one piece, where the overall structure of the fibre mat which was originally applied when the previous composite structure was manufactured is maintained.

The method may further comprise the step of selecting the recycled fibre mats from a pool of recycled fibre mats. Recycled fibre mats which have been retrieved from previous products or structures will most likely not be identical or uniform. For instance, the fibre mats were probably manufactured in a manner which was suitable for the product or structure which they originally formed part of. This could, e.g., include type of fibre material (e.g. glass, or carbon), quality of the original fibres, fibre orientation, size of the fibre mats including dimensions and shape, thickness of the fibre mat, etc. Furthermore, the condition of the fibre mats may reflect the age and/or the use of the original product or structure, e.g. in terms of wear or damage on the fibres. Finally, the method applied for retrieving the fibre mats from the previous product or structure as well as type of resin in the previous structure and amount of residual resin on the mats may have an impact on the condition of the fibre mats, e.g. on the quality of the fibre mats.

Accordingly, when a new composite structure is to be manufactured using recycled fibre mats, it may be relevant to select the fibre mats to be used in order to ensure that the applied fibre mats match the requirements of the new composite structure. If a vast number of fibre mats have been retrieved from a vast number of previous products or structures of various kinds, these retrieved fibre mats may form a pool of recycled fibre mats from which suitable fibre mats can be selected for use in a new composite structure.

The method may further comprise the step of categorising the recycled fibre mats of the pool of recycled fibre mats based on quality of the recycled fibre mats, and the step of selecting the recycled fibre mats may include taking the categorisation of the fibre mats into account.

According to this embodiment, the quality of the recycled fibre mats is evaluated. This could, e.g., include evaluating wear and/or damage of the fibres of the fibre mats, caused by the previous use. Furthermore, the quality of the original fibre mats may differ, e.g. due to various quality requirements of the products or structures which the fibre mats originally formed part of. By categorising the fibre mats of the pool of fibre mats based on the quality of the fibre mats, it is easy to select fibre mats of a required or appropriate quality grade for the new composite structure.

Alternatively or additionally, the method may further comprise the step of categorising the recycled fibre mats of the pool of recycled fibre mats based on fibre orientation and/or dimensions/shape of the recycled fibre mats, and the step of arranging layers of fibre mats in a mould may include optimizing orientation of fibre mats so as to provide anisotropic properties of the composite structure. It is particularly preferred to take into account both fibre orientation and dimensions/shape of the recycled fibre mats when arranging the fibre mats, as this allows for a reduced use of fibre mats and therefore a reduced use of resin to connect the fibre mats of the composite structure. Hence a more environmentally friendly product may be produced through a reduction in resources used.

According to this embodiment, the categorisation of fibre mats based on fibre orientation allows for easy selection of fibre mats with suitable and desired fibre orientation from the pool of fibre mats for the new composite structure. Furthermore, when arranging the selected fibre mats in the mould, the fibre orientation of the respective fibre mats is taken into account, in such a manner that a desired optimized fibre pattern is obtained, which results in desired anisotropic properties of the resulting composite structure. Anisotropic properties generally allow for focusing fibres in areas and directions where the composite structure will experience highest loads during use. This way the fibre content may be reduced as compared to composite structures where the fibres are arranged to allow for highest load in all areas and directions. It is particularly preferred to take into account both fibre orientation and dimensions/shape of the recycled fibre mats when arranging the fibre mats, as this allows for a reduced use of fibre mats by reducing or eliminating overlapping of fibre mats beyond what is structurally required. Thereby therefore the consumption of resin to connect the fibre mats of the composite structure may be reduced and an overall lighter composite structure may be produced. This also leads to a more environmentally friendly product through a reduction in resources used.

The step of categorising the recycled fibre mats may be performed at least partly by means of automated visual inspection. According to this embodiment, there is no or only minimal manual involvement in the categorisation of the recycled fibre mats. This reduces the costs of recycling the fibre mats, while allowing for appropriate selection of suitable recycled fibre mats for a given new composite structure.

The automated visual inspection may, e.g., be performed using an automated visual inspection system, e.g. comprising a camera or a similar optically based device or vision-based system. The automated visual inspection system may be able to detect or recognise fibre orientation, fibre thickness, fibre density, dimensions and shape, etc., of the fibre mats. Alternatively or additionally, the automated visual inspection system may be able to detect or recognise damages, defects, imperfections, etc., in the fibre mats, which may have an impact on the quality grade of the fibre mats. The automated visual inspection may, e.g., involve artificial intelligence (AI) or machine learning. The acquired data of the visual inspection of the individual recycled fibre mats is preferably stored in an electronic database accessible for later selection and retrieval of mats as well as optimizing design and layup of mats in moulds.

The step of arranging layers of fibre mats in a mould may comprise arranging at least some of the recycled fibre mats of a given layer side by side with overlapping edge sections. According to this embodiment, a given layer of fibre mats may be constructed from two or more recycled fibre mats. In order to prevent that a weakness is introduced in regions where the respective recycled fibre mats meet, the recycled fibre mats are positioned with an overlap in such regions. Furthermore, such an overlap may compensate for a possibly reduced quality grade of the recycled fibre mats, as compared to virgin fibre mats. For example an extra layer of fibre mats may be arranged over a damaged region of another mat. This will allow for manufacturing of a composite structure using recycled fibre mats without compromising the quality of the composite structure, notably without compromising the strength of the composite structure. In one example, a width of the overlapping edge sections of recycled fibre mats arranged side by side is above a first threshold value, such as at least 1 cm. This may compensate for weaknesses in border regions of recycled mats for example arisen during the process of retrieving the recycled fibre mats. In another example the width of the overlapping edge sections is below a second threshold value, such a below 20% of a width the recycled fibre mats arranged side by side with overlapping edge sections. This may prevent excessive use of fibre mats and allow for more achieving more homogeneous properties of the resulting composite structure through allowing for more layers of fibres instead of creating zones of adjacent stacks of mats in the layup.

In one example, the recycled fibre mats are of standardized size and/or shape of relatively small size, such as having dimensions of less than 25 cm×less than 25 cm. Then the layers of fibre mats are formed by randomly arranging a plurality of such standardized mats in the mould, so there are at least 10 layers of fibre mats everywhere. It was found that such random arrangement of standardized recycled mats provided substantially isotropic properties in the plane of the mould including levelling out variation in quality of the recycled fibre mats. Hence a simple and fast layup is realized providing predictable properties of the final composite structure even if the reused fibre mats exhibited considerable variation in quality.

The recycled fibre mats may comprise oriented glass fibres and/or oriented carbon fibres. Glass fibres and carbon fibres are the most used fibre mats in composite structures and hence will in time also be the most widely available recycled fibre mats. The present invention therefore enables a significant environmental progress in providing a route to recycling of the fibre fraction of such composite structures. Furthermore, due to the abundance of sources for recycled fibre mats comprising oriented glass fibres and/or carbon fibres, such recycled fibre mats may in time be relatively affordable compared to other types of recycled fibre mats.

The method may further comprise the step of arranging at least one core layer between layers of fibre mats in the mould, prior to the step of infusing a resin in the layers of fibre mats. According to this embodiment, the composite structure may form a sandwich composite structure. The infusion resin will then both infuse the fibre mats and adhere the fibre mats to the core structure. The core layer is typically a light and affordable material such as a polymer foam, a honeycomb structure, or a wood layer, such as for example a layer of laminated veneer lumber layer or a layer of plywood. The wood is preferably balsa wood, but other well-known types of wood or combinations of wood may also be used.

This allows for relatively stiff and light composite structures. A composite structure may also comprise more than one layer of core material arranged between layers of recycled fibre mats. For instance, core layers of wood and layers of recycled fibre mats may be arranged alternatingly and bonded together. The at least one core layer may be a continuous layer of wood, such as a strip or a two-dimensional plate or mat.

Alternatively or additionally, other kinds of material may be added, e.g. in the form of one or more further layers of material. Examples of other suitable kinds of material include, but are not limited to, carbon fibres, foam metal or natural fibres other than wood.

In one example, the method comprises the step of arranging one or more layers of virgin fibre mats (i.e. fibre mats that are not recycled and hence have not previously been incorporated in and retrieved from composite structures) above, below and/or between layers of recycled fibre mats. For larger composite structures, virgin fibre mats may alternatively be arranged close to outer edges of the composite structure to overcome concerns on edges of the recycled fibre mats potentially reduced properties. However, it is preferred that the majority of the fibre mats of the composite structure is recycled fibre mats.

The method may further comprise the step of adjusting a shape and/or a size of at least one of the recycled fibre mats prior to or after arranging the at least one of the recycled fibre mats in the mould. According to this embodiment, the shape and/or size of the respective recycled fibre mats may be adjusted so that the layers of recycled fibre mats match the size and shape of the mould. The recycled fibre mats may either have the size and shape which was suitable for their previous, original use, or have a standard size and shape. Such original or standard size and shape may not be suitable for the new composite structure, and it is therefore an advantage to adjust the shape and/or size of the recycled fibre mats so as to match the mould and the requirements of the new composite structure.

The method may further comprise the step of chemically and/or mechanically cleaning at least one of the recycled fibre mats prior to arranging the recycled fibre mats in the mould. According to this embodiment, residues from the product or structure which the recycled fibre mat originally formed part of are removed before the fibre mat is arranged in the mould for reuse, thereby putting the recycled fibre mat in a better shape for reuse. This could, e.g., include removing residues of a matrix of epoxy resin. Chemical cleaning of the fibre mat may, e.g., include applying a solvent, a release agent or the like to the retrieved fibre mat. This may, e.g., cause particles, such as epoxy particles, being stuck to the fibres of the fibre mat to chemically break and/or be released from the fibres. Mechanical cleaning of the fibre mat may, e.g., include washing, e.g. by applying water, and possibly surfactant or soap, rubbing, rolling, bending, compressing, applying a pressurized fluid, e.g. water or air, etc. Such mechanical cleaning may, e.g., cause particles, such as epoxy particles, being stuck to the fibres of the fibre mat to mechanically break and/or be mechanically released from the fibres.

The method may further comprise the step of providing a sizing and/or a primer to at least one of the recycled fibre mats prior to or after arranging the at least one of the fibre mats in the mould. Providing a sizing and/or a primer to the recycled fibre mat, e.g. to the surface of the fibres of the fibre mat, improves the properties of the fibre mat in terms of adherence to the resin of the new composite structure.

Alternatively or additionally, another suitable agent may be added to the surface of the fibres of the fibre mat and/or other suitable kinds of treatment of the recycled fibre mats may be provided in order to improve their properties with regard to forming part of the new composite structure.

The mould may be generally flat. According to this embodiment, the resulting composite structure may have a generally planar or plate-like shape. This allows for better handling the possible higher stiffness of recycled mats compared to mats of virgin fibres. In this case the resulting composite structure may, e.g., be a standard element, e.g. for use in the building industry, such as a panel or the like.

As an alternative, the mould may have a shape and size which corresponds to the shape and size of a new composite structure to be used directly.

### BRIEF DESCRIPTION OF THE DRAWINGS

The invention will now be described in further detail with reference to the accompanying drawings in which

FIG. 1 is a perspective view of a wind turbine,

FIGS. 2 and 3 illustrate a wind turbine blade to be processed for recycling,

FIGS. 4-7 illustrate steps of a method for retrieving a recycled fibre mat from a composite structure,

FIG. 8 illustrates steps of an alternative method for retrieving a recycled fibre mat from a composite structure,

FIGS. 9-15 illustrate method steps of a method for manufacturing a composite structure according to an embodiment of the invention, and

FIG. 16 shows a composite structure having been manufactured in accordance with a method according to an embodiment of the invention.

FIG. 17 shows another composite structure having been manufactured in accordance with a method according to an embodiment of the invention.

### DETAILED DESCRIPTION OF THE DRAWINGS

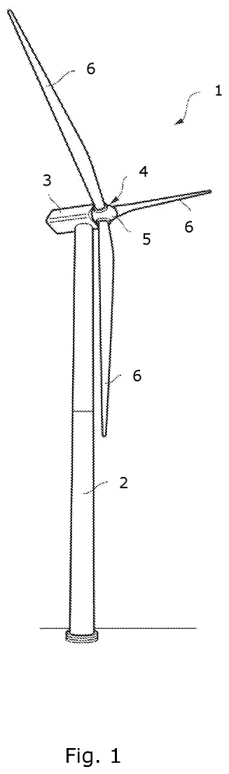

FIG. 1 is a perspective view of a wind turbine 1 comprising a tower 2 and a nacelle 3 mounted on top of the tower 2. A rotor 4 with a hub 5 carrying three wind turbine blades 6 is mounted rotatably on the nacelle 3. Accordingly, wind acting on the wind turbine blades 6 causes the rotor 4 to rotate, and the mechanical energy is transformed into electrical energy by means of a generator (not shown), in a manner which is known per se.

When the wind turbine 1, or one or more components of the wind turbine 1, has reached its end of life, it will be decommissioned. To this end, it is desirable to recycle the material of the various components to the greatest possible extent. In particular, the material of the wind turbine blades 6, which is often a composite material, may advantageously be fully or partly recycled, e.g. by applying a method according to an embodiment of the invention.

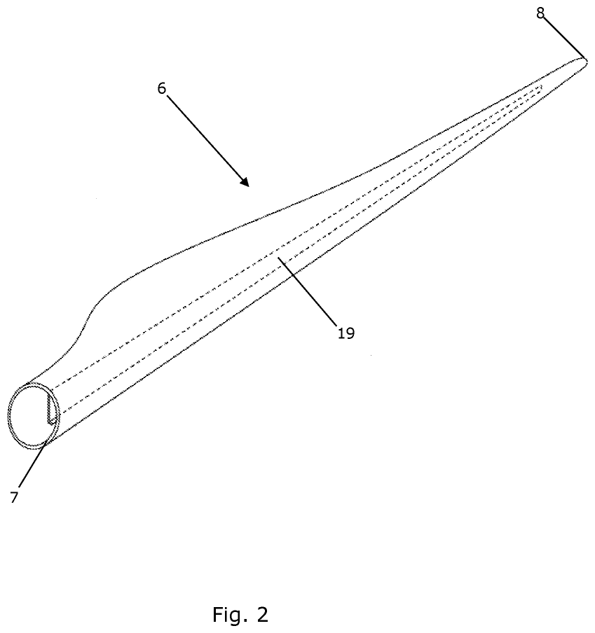

FIG. 2 is a perspective view of a composite structure in the form of a wind turbine blade 6. The wind turbine blade 6 extends in a longitudinal direction between a root end 7 and a tip end 8. A web 19 extends along the longitudinal direction inside the wind turbine blade 6 between a pressure side and a suction side.

The wind turbine blade 6 of FIG. 2 has been demounted from a wind turbine, and the composite material of the wind turbine blade 6 is about to be at least partly recycled by means of a method according to an embodiment of the invention. This will be described in further detail below.

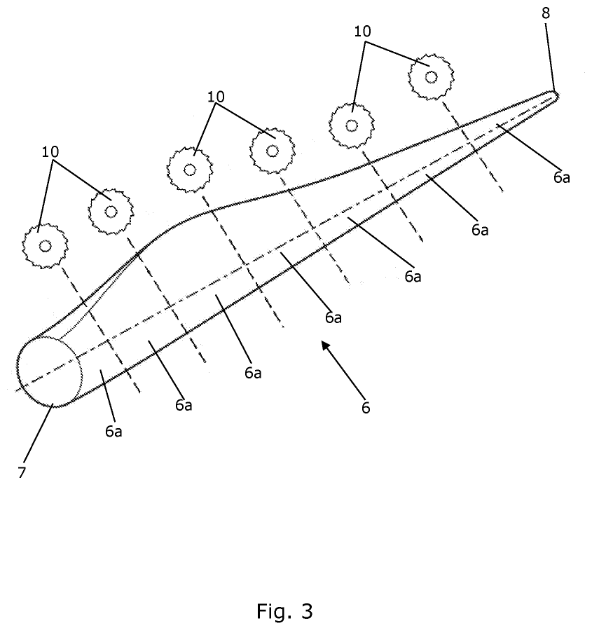

FIG. 3 illustrates the wind turbine blade 6 of FIG. 2 in the process of being cut into smaller parts 6a, the cutting step being illustrated by saw blades 10. The smaller parts 6a are easier to manage than the entire wind turbine blade 6, and each of the smaller parts 6a constitutes a composite structure. It should, however, be mentioned that the cutting step illustrated in FIG. 3 is optional, and that the method steps described below could, alternatively, be performed on the intact wind turbine blade 6, as it is illustrated in FIG. 2.

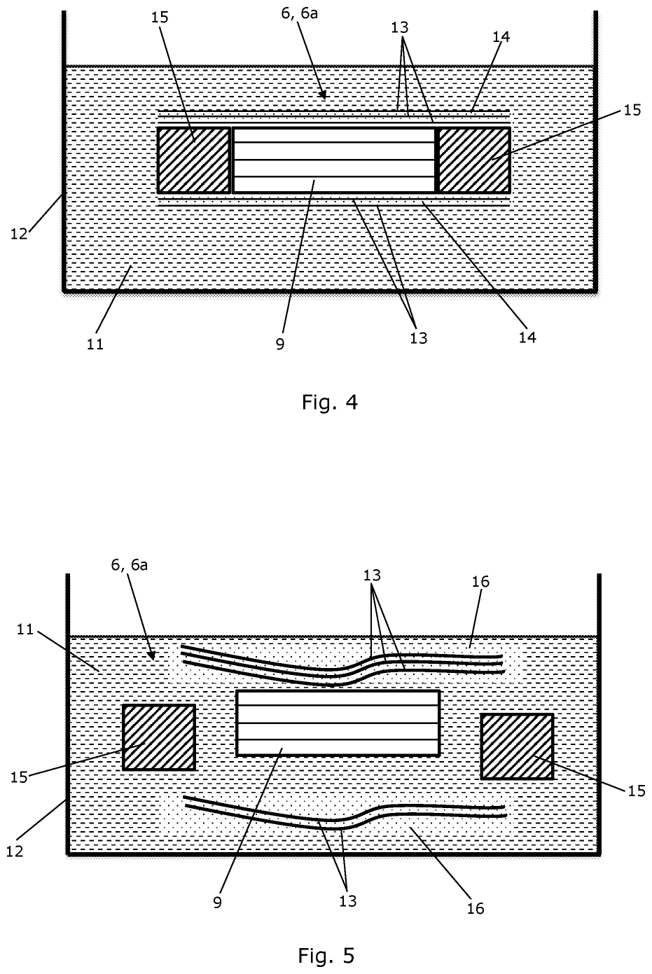

FIGS. 4-7 illustrate method steps for retrieving a recycled fibre mat from a composite structure. In FIG. 4, an epoxy composite structure, in the form of a wind turbine blade 6 or a part 6a of a wind turbine blade, has been submerged in a release agent 11 accommodated in a vessel 12. The epoxy composite structure 6, 6a comprises a plurality of fibre mats 13, five of which are shown, embedded in a matrix of cured epoxy resin 14. The fibre mats 13 may comprise oriented or random fibres, e.g. glass fibres. Furthermore, the epoxy composite structure 6, 6a comprises two core members 15 and a spar cap 9.

The release agent 11 may comprise acid, such as formic acid, and it acts on the epoxy composite structure 6, 6a in such a manner that the epoxy composite structure 6, 6a disintegrates. More particularly, the release agent 11 causes swelling of epoxy polymers of the epoxy resin 14, and this causes the cured epoxy resin 14 to disintegrate into swelled epoxy particles. This, in turn, releases the fibre mats 13, as well as the core members 15 and the spar cap 9, from the matrix of epoxy resin 14.

In FIG. 5, the release agent 11 has acted on the composite structure 6, 6a for sufficiently long to have caused the disintegration of the composite structure 6, 6a described above with reference to FIG. 4. In particular, it can be seen that the fibre mats 13 are now floating freely in a mix 16 of release agent and disintegrated epoxy resin. Accordingly, the fibre mats 13 can be retrieved in one piece, and with their original fibre orientation, from the mix 16 of release agent and disintegrated epoxy resin.

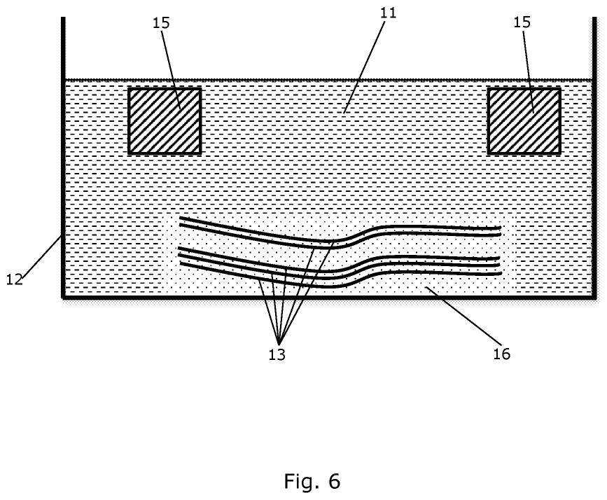

In FIG. 6, the spar cap has been retrieved from the vessel accommodating the release agent 11. The core members 15 have moved upwards towards the surface of the release agent 11 and the top of the vessel 12, while the mix 16 of release agent and disintegrated epoxy resin has moved downwards towards the bottom of the vessel 12, along with the released fibre mats 13.

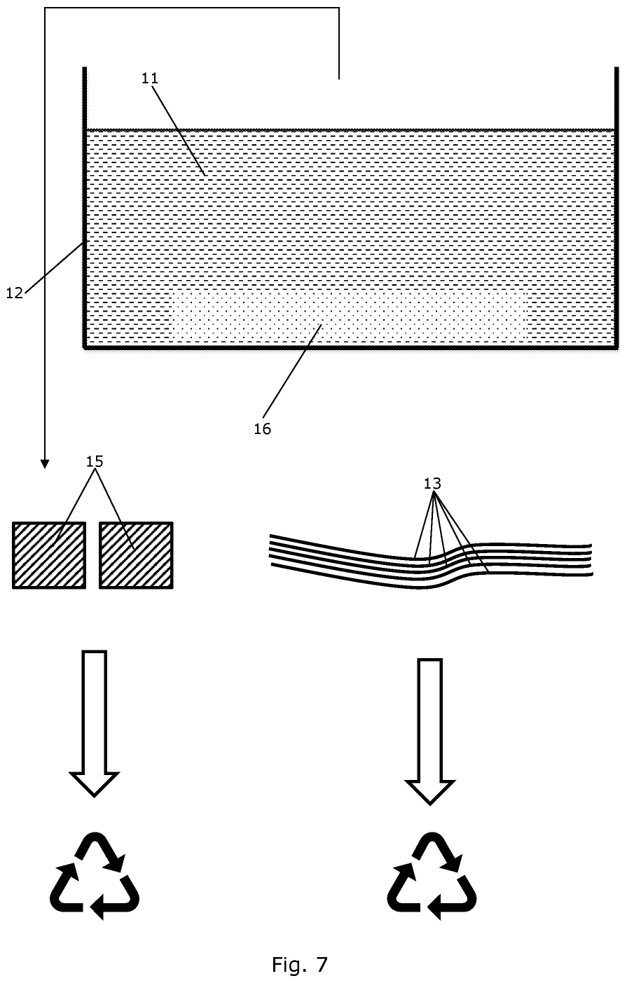

In FIG. 7, the core members 15 as well as the fibre mats 13 have been retrieved from the vessel 12 accommodating the release agent 11, and each of these components 13, 15 are now ready for recycling. This could, e.g., include reusing the fibre mats 13 or the core members 15 in their retrieved form, e.g. as components of a new composite structure. As an alternative, the material of the fibre mats 13 or the core members 15 may simply be recycled. This may, e.g., include remelting the fibres of the fibre mats 13.

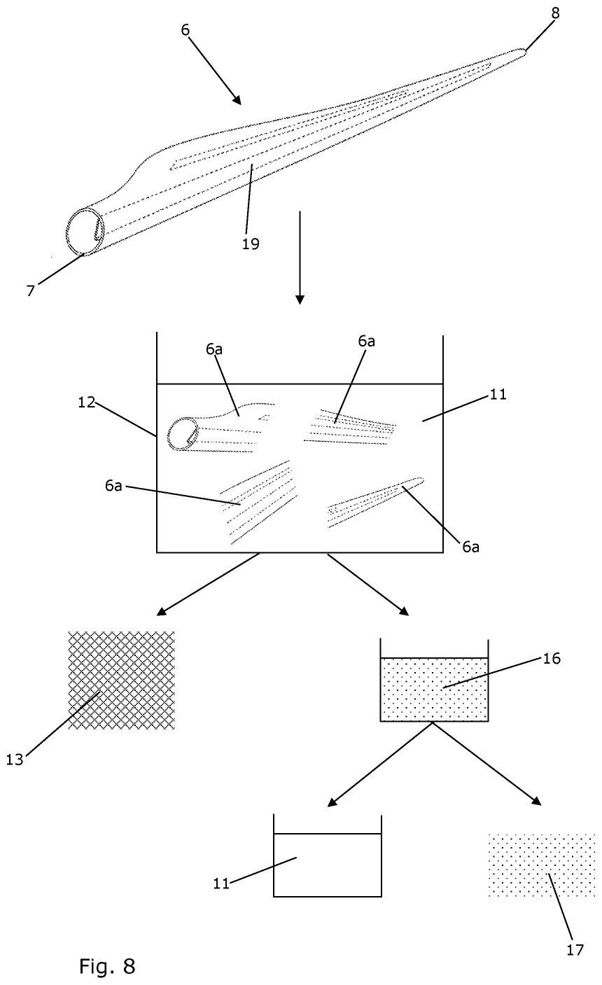

FIG. 8 illustrates method steps of an alternative method for retrieving a recycled fibre mat from a composite structure. A wind turbine blade 6 is initially cut into smaller parts 6a, e.g. in the manner illustrated in FIG. 3. The smaller parts 6a are submerged in a release agent 11 accommodated in a vessel 12. This causes the composite structures, in the form of the smaller parts 6a, to disintegrate, e.g. in the manner described above with reference to FIGS. 4-7. Accordingly, at least one fibre mat 13 is retrieved in one piece, and with its original fibre orientation. This allows the fibre mat 13 to be reused directly, in its retrieved form. In the fibre mat 13 illustrated in FIG. 8, the fibres have a bidirectional orientation.

Furthermore, a mix 16 of release agent and epoxy resin is retrieved from the vessel 12. The mix 16 is subsequently separated into release agent 11 and epoxy resin 17. This allows for recycling of the release agent 11 as well as of the epoxy resin17.

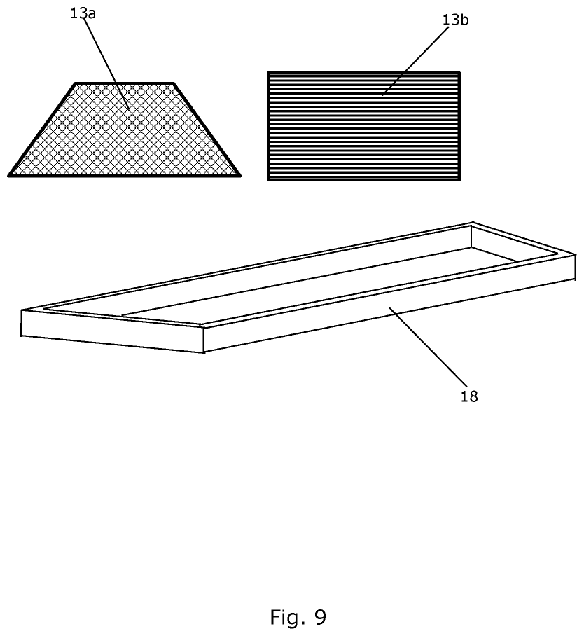

FIGS. 9-15 illustrate method steps of a method for manufacturing a composite structure according to an embodiment of the invention. FIG. 9 shows a mould 18 and two recycled fibre mats 13a, 13b. The fibre mats 13a, 13b may, e.g., have been retrieved from one or two original composite structures, e.g. in the manner described above with reference to FIGS. 4-8.

Fibre mat 13a has a trapezial shape, and it comprises oriented fibres arranged in a bidirectional pattern. Fibre mat 13b has a rectangular shape, and it comprises oriented fibres arranged in a unidirectional pattern. Accordingly, the shape as well as the fibre orientation of fibre mat 13a differs from the respective shape and fibre orientation of fibre mat 13b.

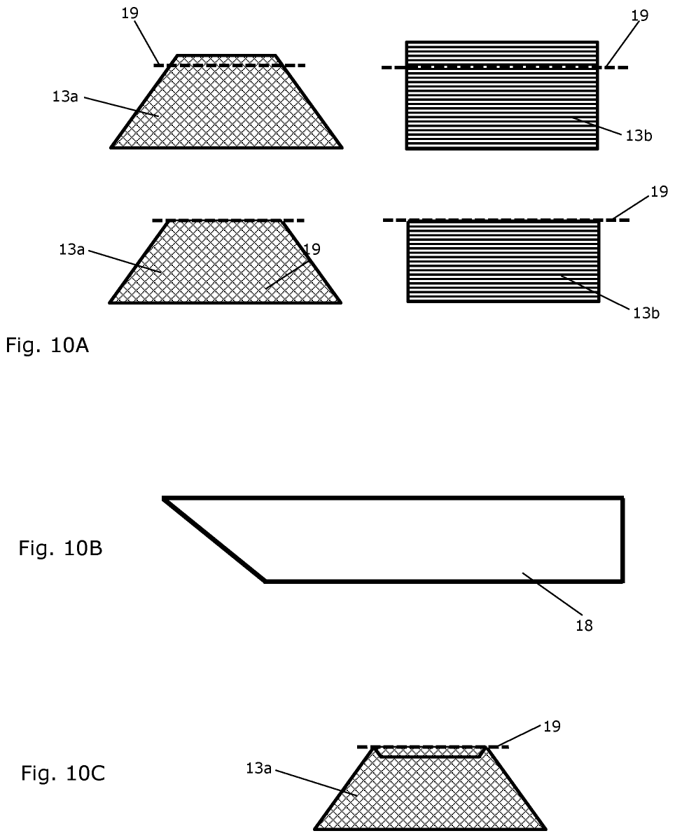

The fibre mats 13a, 13b have shapes and sizes which do not readily fit in the mould 18. Accordingly, as illustrated in FIG. 10A, the fibre mats 13a, 13b are cut along line 19, in order to enable the thus adapted fibre mats 13a, 13b to fit into the mould. In FIG. 10B, the mould 18 is seen from above.

As an alternative to cutting the fibre mats 13a, 13b, the fibre mats 13a, 13b may be folded along line 19, as illustrated in FIG. 10C. In this case the excess material of the fibre mats 13a is not removed, and this material will therefore form part of the resulting composite structure. However, the fibre mat 13a is still able to fit into the mould 18.

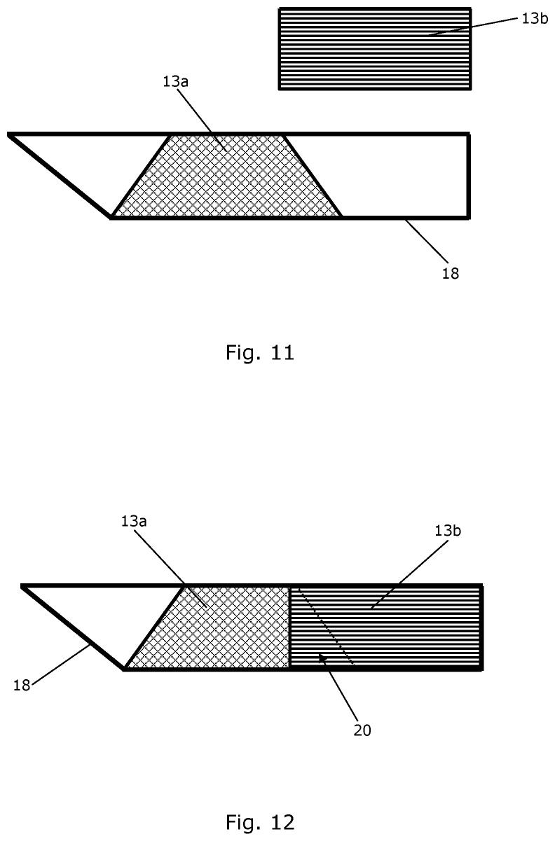

In FIG. 11 fibre mat 13a has been arranged in the mould 18, and in FIG. 12 fibre mat 13b has additionally been arranged in the mould 18. The fibre mats 13a, 13b are positioned in the mould 18 in such a manner that edge sections of the fibre mats 13a, 13b overlap in an overlapping region 20. Accordingly, the fibre mats 13a, 13b form part of a layer of fibre mats 13a, 13b, where the overlapping region 20 ensures that a weakness is not introduced in the layer of fibre mats 13a, 13b due to the fibre mats 13a and 13b being joined. Accordingly, the overlapping region 20 may compensate for the fact that the layer is constructed from multiple recycled fibre mats 13a, 13b instead of a single perfect-fit virgin fibre mat forming a sheet.

Furthermore, the fibre orientation varies across the layer of fibre mats 13a, 13b, due to the different fibre orientation of fibre mat 13a and fibre mat 13b, respectively. Thus, the fibre mats 13a, 13b may be selected and positioned in the mould 18 in such a manner that the fibre orientation of the resulting layer of fibre mats 13a, 13b matches requirements of the resulting composite structure, e.g. with respect to desired anisotropic properties of the resulting composite structure. Alternatively, multiple layers with random or preselected fibre orientation may yield a composite structure with substantially isotropic properties in the plane of the mould.

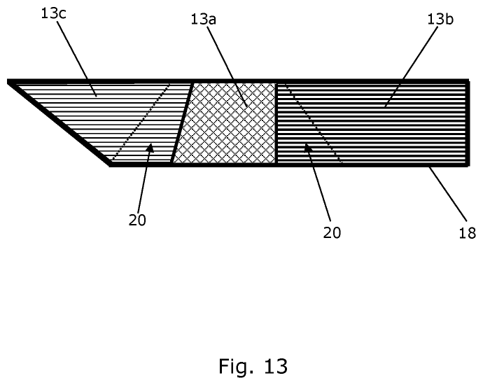

In FIG. 13, a third fibre mat 13c has additionally been positioned in the mould 18. The third fibre mat 13c comprises oriented fibres arranged in a unidirectional pattern, and it is arranged in such a manner that an overlapping region 20 is defined with fibre mat 13a. Thus, the fibre mats 13a, 13b, 13c in combination cover the entire mould 18 and form a complete layer of fibre mats 13a, 13b, 13c.

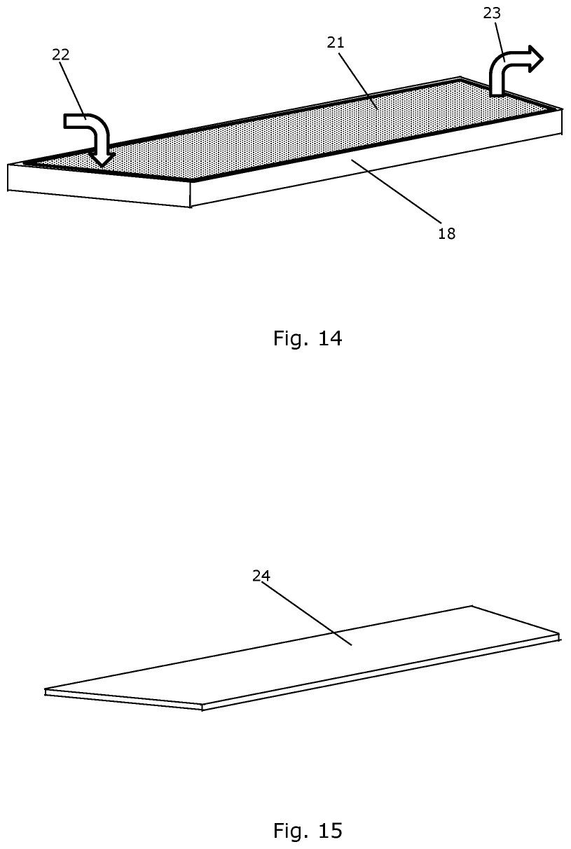

In FIG. 14, several layers of fibre mats (not shown) have been arranged in the mould 18, in the manner described above with reference to FIGS. 9-13. Furthermore, a vacuum bag 21 has been arranged on top of the layers of fibre mats to form a closure of the mould 18. A vacuum is created via vacuum tube 23 and resin is infused in the layers of fibre mats via resin tube 22. Other methods of providing the resin into the layers of fibre mats are known to the skilled person and vacuum assisted resin infusion is only one example. However, vacuum assisted resin infusion is the preferred method due to the versatility, speed and maturity of the process. The resin is allowed to cure, thereby forming a composite structure comprising the fibre mats embedded in a matrix of cured resin. FIG. 15 shows the resulting composite structure 24 released from the mould.

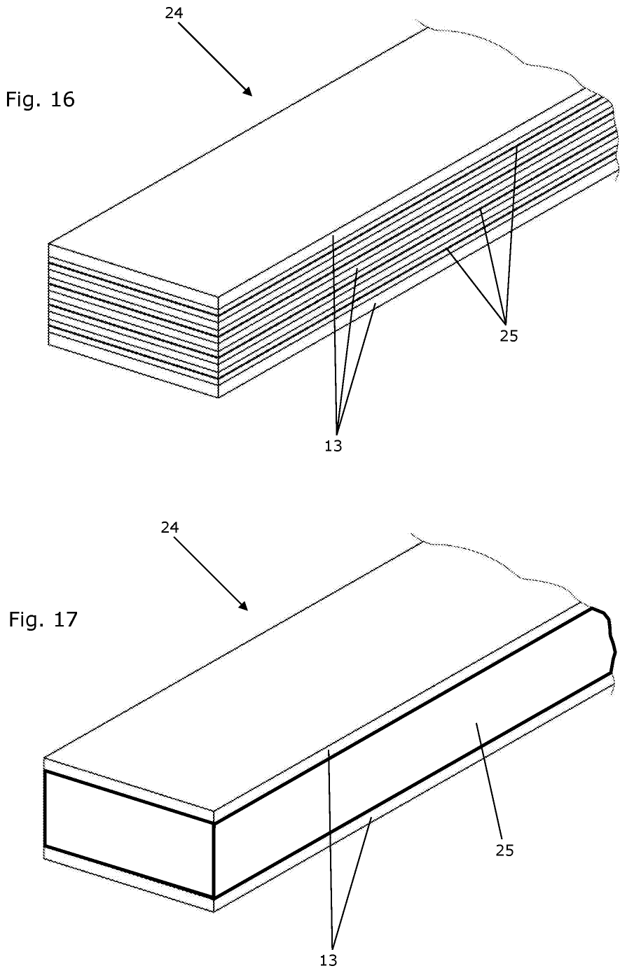

FIG. 16 shows a composite structure 24, which has been manufactured in accordance with a method according to an embodiment of the invention. The composite structure 24 comprises multiple alternating layers of recycled fibre mats 13 and wood 25. Applying layers of core material 25, such as wood in the composite structure 24, in addition to layers of recycled fibre mats 13, provides a composite structure 24 with a combination of relatively high stiffness and low weight.

FIG. 17 shows another composite structure 24, which has been manufactured in accordance with a method according to an embodiment of the invention. Here, the composite structure 24 is a sandwich structure with two outer layers each comprising one or more layers or recycled fibre mats 13, and a foam core material 25 arranged therebetween. The foam core material may for example be virgin core, a core prepared by remelted thermoplastic recycled core material 15 (see FIG. 7) or core material recovered from a recycling process as described in relation to FIG. 7 reused directly in the retrieved form. After infusion and curing, this allows for a composite structure 24 having high stiffness and low weight.

1. A method for manufacturing a composite structure, the method comprising:
arranging layers of fibre mats in a mould, the fibre mats comprising oriented fibres,
infusing a resin in the layers of fibre mats, and
curing the resin to form the composite structure,
wherein the fibre mats are recycled fibre mats.

2. The method according to claim 1, further comprising selecting the recycled fibre mats from a pool of recycled fibre mats.

3. The method according to claim 2, further comprising categorising the recycled fibre mats of the pool of recycled fibre mats based on quality of the recycled fibre mats, and wherein the step of selecting the recycled fibre mats includes taking the categorisation of the fibre mats into account.

4. The method according to claim 2, further comprising categorising the recycled fibre mats of the pool of recycled fibre mats based on fibre orientation and/or dimensions/shape of the recycled fibre mats, and wherein the step of arranging layers of fibre mats in a mould includes optimizing orientation of fibre mats so as to provide anisotropic properties of the composite structure.

5. The method according to claim 3, wherein categorising the recycled fibre mats is performed at least partly by means of automated visual inspection.

6. The method according to claim 1, wherein arranging layers of fibre mats in a mould comprises arranging at least some of the recycled fibre mats of a given layer side by side with overlapping edge sections, preferably a width of the overlapping edge sections is above a first threshold value, such as at least 1 cm and/or the width of the overlapping edge sections is below a second threshold value, such a below 20% of a width the recycled fibre mats arranged side by side with overlapping edge sections.

7. The method according to claim 1, wherein the recycled fibre mats comprise oriented glass fibres and/or oriented carbon fibres.

8. The method according to claim 1, further comprising arranging at least one layer of core material along with the layers of fibre mats in the mould, prior to the step of infusing a resin in the layers of fibre mats.

9. The method according to claim 1, further comprising the step of adjusting a shape and/or a size of at least one of the recycled fibre mats prior to or after arranging the at least one of the recycled fibre mats in the mould.

10. The method according to claim 1, further comprising chemically and/or mechanically cleaning at least one of the recycled fibre mats prior to arranging the recycled fibre mats in the mould.

11. The method according to claim 1, further comprising the step of providing a sizing and/or a primer to at least one of the recycled fibre mats prior to or after arranging the at least one of the fibre mats in the mould.

12. The method according to claim 1, wherein the mould is generally flat.

13. The method according to claim 1, wherein the fibre mats are of standardized size and/or shape having dimensions of less than 25 cm×less than 25 cm and the layer of fibre mats are formed by randomly arranging a plurality of the fibre mats.
